(19) United States
(12) Patent Application Publication
(10) Pub. No.: US 2019/0205611 A1
(43) Pub. Date: Jul. 4, 2019

(54) QUALITY-BASED TEN-PRINT MATCH SCORE NORMALIZATION

(71) Applicant: MorphoTrak, LLC, Anaheim, CA (US)

(72) Inventors: Peter Zhen-Ping Lo, Mission Viejo, CA (US); Hui Zhu, Anaheim, CA (US); Hui Chen, Foothill Ranch, CA (US)

(73) Assignee: MorphoTrak, LLC, Anaheim, CA (US)

(21) Appl. No.: 16/191,534

(22) Filed: Nov. 15, 2018

Related U.S. Application Data
(60) Provisional application No. 62/612,334, filed on Dec. 30, 2017.

(51) Int. Cl. G06K 9/00; G06F 17/30; G06K 9/62

(52) U.S. Cl. CPC G06K 9/00087; G06K 9/6218; G06K 9/6228; G06F 17/30247

(57) ABSTRACT

In some implementations, a system is capable of improving the results of a matching operation by normalizing match scores with respect to quality levels of compared fingerprints and/or attributes of the compared fingerprints. The system initially obtains match data of the matching operation. The match data can include baseline record match scores for a set of reference records that are compared against a search record. The system then uses normalization techniques to normalize the values of the baseline record match scores with respect to, for example, quality levels of the search and reference records, and various attributes of the compared fingerprints, such as fingerprint quality, finger position, and detected fingerprint patterns. The normalized record match scores can therefore be used to more accurately represent the similarity between the search record and the reference records.

### CROSS-REFERENCE TO RELATED APPLICATIONS

This application claims the benefit of U.S. Provisional Patent Application No. 62/612,334 filed on Dec. 30, 2017 and titled “QUALITY-BASED TEN-PRINT MATCH SCORE NORMALIZATION,” which is incorporated herein by reference in its entirety.

### FIELD

The present specification relates generally to automatic fingerprint recognition systems.

### BACKGROUND

Pattern matching systems such as ten-print or fingerprint identification systems play a critical role in criminal and civil applications. For example, fingerprint identification is often used to identify and track suspects and in criminal investigations. Similarly, fingerprint verification is used in civil applications to prevent fraud and support other security processes.

### SUMMARY

In some implementations, a system is capable of improving the results of a matching operation by normalizing match scores with respect to quality levels of compared fingerprints and/or attributes of the compared fingerprints. The system initially obtains match data of the matching operation. The match data can include baseline record match scores for a set of reference records that are compared against a search record. The system then uses normalization techniques to normalize the values of the baseline record match scores with respect to, for example, quality levels of the search and reference records, and various attributes of the compared fingerprints, such as fingerprint quality, finger position, and detected fingerprint patterns. The normalized record match scores can therefore be used to more accurately represent the similarity between the search record and the reference records.

The system can be configured to perform quality-based matching to improve speed and accuracy when comparing a search record and a reference record. For example, the system can incrementally compare search fingerprint images and reference fingerprint images on a finger-by-finger basis so that a detected match of any particular finger can be used to terminate the matching operation and prevent unnecessary comparisons with other fingerprint images that have not yet been compared. In this respect, the system can be configured to perform fingerprint matching in a more efficient manner relative to traditional fingerprint matching techniques used by many AFISs.

As another example, the system can perform fingerprint matching using a set of quality clusters that are each associated with a different quality level. The system can re-organize search fingerprint images within a search record into different quality clusters based on their respective quality levels. The system then generates, for each quality cluster, one or more search packages that each include a certain number of search fingerprint images based on a matching accuracy requirement for the matching operation. The system then compares search fingerprint images assigned to search packages of a certain quality cluster to corresponding reference fingerprint images included in a reference record that is associated with the quality cluster of the search packages. For instance, the reference record that is compared to the search fingerprint images can have a quality level that corresponds to a quality level of the quality cluster that includes the search fingerprint images. In this respect, the system can use the quality levels of individual search fingerprint images within the search record and/or the quality levels of reference records to improve the overall accuracy of the matching operation.

After a matching operation has been completed, the system obtains match data that includes hierarchal similarity information for the fingerprints that were compared matching operation. The match data can include various types of match scores that each represent different hierarchal level of similarity between a search record and a reference record. For example, a fingerprint pair match score represents a similarity between an individual search fingerprint image and an individual reference fingerprint image compared to the search fingerprint image. As another example, a package match score represents an aggregate similarity of search fingerprint images within a particular search package of a quality cluster and the corresponding reference fingerprint images of a reference record that are compared to the search fingerprint images. As yet another example, a reference match score represents an overall similarity of all search fingerprint images of a quality cluster and the corresponding reference fingerprint images of a reference record that are compared to all of the search fingerprint images of the quality cluster. In some implementations, the reference match score can be used to determine whether the reference record is a match candidate for the search record.

The system can use different sets of normalization parameters to normalize the various match scores that are included in the match data. For instance, the system can normalize pair match scores of reference fingerprint images and/or search fingerprint images at the search package level. In such instances, the system can initially group individual search fingerprint images within a particular search package as belonging to a particular normalization group based on fingerprint attributes. The system then determines normalization parameters for each of the normalization groups. As an example, for a particular normalization group, the system applies the normalization parameters of the group to baseline pair match scores of search fingerprint images that are included in the particular normalization group. The system computes normalized pair match scores for the fingerprints that are included in the particular normalization group based on applying the normalization parameters.

The system can also perform normalization on record match scores of reference records at the quality cluster level. In such instances, the system initially computes a baseline record match score for each reference record that is compared to the search record during the matching operation. As an example, the system computes the record match score for a reference record based on combining the package match scores that are associated with a reference record. In this example, the system then determines normalization parameters for the quality cluster that is associated with the reference record. The system applies the normalization parameters of the quality cluster to the baseline record match score of the reference record. Then system then computes a normalized record match score for the reference record that is then provided as output in a match report.

The system can utilize the various techniques discussed above, and in greater detail below, to improve the quality of a match report for a given matching operation. For example, the system can use the normalization techniques to adjust the value of a record match score for a reference record so that it more accurately represents the overall similarity between a search record and the reference record. In some implementations, the system can incrementally generate the match report as the matching operation is being performed so that if a certain reference record that is highly likely to represent a match candidate for the search record is identified, the system can stop the matching operation and just provide the incrementally generated match report that includes the most-recent record match score of the reference record that is highly likely to represent a match candidate (any the match scores of any preceding reference records that were previously compared). The system can therefore provide a match report for output using this technique even before the matching operation has been completed.

In one general aspect, a method can be performed by one or more computers. The method can include the operations of obtaining match data for a matching operation between a search record and a reference record. The match data identifies at least: search fingerprint images included within the search record, one or more attributes of each of the search fingerprint images, a selected quality cluster that (i) is associated with the search record, and (ii) comprises one or more search packages, each search package representing a different subset of the search fingerprint images. Additionally, the method includes computing a baseline reference match score for the reference record based on the obtained match data; determining a set of normalization parameters for the selected quality cluster based at least on the one or more attributes of the search fingerprint images; computing a normalized reference match score for the reference record based on the set of normalization parameters for the selected quality cluster and the baseline reference match score; and providing the normalized reference match score for output in a match report for the matching operation.

One or more implementation can include the following optional features. For example, in some implementations, the one or more attributes of the search fingerprint images include: quality levels of each of the search fingerprint images, finger types of each of the search fingerprint images, and fingerprint patterns identified in the search fingerprint images; and the set of normalization parameters for the selected quality cluster is determined based least on the quality levels of each of the search fingerprint images, the finger types of each of the search fingerprint images and the fingerprint patterns identified in the search fingerprint images.

In some implementations, the matching operation is performed according to a matching accuracy requirement; the match data for matching operation identifies quality levels of the search fingerprint images; and the method further includes assigning a particular subset of the fingerprints to the one or more search packages based on the matching accuracy requirement and the quality levels of each of the search fingerprint images.

In some implementations, the match data further includes a respective package match score computed in association with the one or more search packages during the matching operation. In such implementations, the baseline reference match score for the reference record is computed based on combining the search package scores for the one or more packages.

In some implementations, the method further includes computing a search packet match score for a particular search package from among the one or more search packets. In such implementations, the computation includes: identifying two or more search fingerprint images represented by the particular search package; obtaining pair match data for the two or more search fingerprint images represented by the particular search package, the pair match data comprising a respective baseline pair match score for each of the two or more search fingerprint images represented by the particular search package. Additionally, for each of the two or more search fingerprint images represented by the particular search package, the method includes: classifying a particular search fingerprint image as belonging to a particular normalization group based on a finger type of the particular search fingerprint image, fingerprint patterns detected within the particular search fingerprint image, and a quality level of the particular search fingerprint image; identifying a set of normalization parameters for the particular normalization group; and computing a normalized pair match score for the particular search fingerprint image based on the set of normalization parameters and a baseline pair match score of the particular search fingerprint image; and computing the search packet match score for the particular search package based on combining the normalized pair match scores for the two or more search fingerprint images represented by the particular search package.

In some implementations, each baseline pair match score for the two or more search fingerprint images represented by the particular search package reflects a similarity between a particular search fingerprint image and a corresponding reference fingerprint image of the reference record. In such implementations, the corresponding reference fingerprint image is associated with a finger type that matches a finger type of the particular search fingerprint image.

In some implementations, the method further includes: obtaining training data indicating (i) predefined normalization groups, and (ii) fingerprint data associated with the predefined normalization groups; and comparing the finger type of the particular search fingerprint image, the fingerprint patterns detected within the particular search fingerprint image, and the quality level of the particular search fingerprint image to corresponding portions of the fingerprint data associated within the predefined normalization groups. In such implementations, classifying the particular search fingerprint image as belonging to the particular normalization group includes: determining, based on comparing the finger type of the particular search fingerprint image, the fingerprint patterns detected within the particular search fingerprint image, and the quality level of the particular search fingerprint image to corresponding portions of the fingerprint data associated within each of the one or more predefined normalization groups, that a corresponding portion of the fingerprint data associated with a particular predefined normalization group best corresponds to the finger type of the particular search fingerprint image, the fingerprint patterns detected within the particular search fingerprint image, and the quality level of the particular search fingerprint image from among the predefined normalization groups.

In some implementations, the selected quality cluster represents (i) a quality cluster having search fingerprint images of the highest quality level, and is (ii) selected from among multiple quality clusters that have search fingerprint images of different quality levels.

In some implementations, providing the normalized reference match score for output in the match report for the matching operation includes: determining that the normalized reference match score satisfies a predetermined threshold value; and in response to determining that the normalized reference match score satisfies the predetermined threshold value, including the normalized reference match score in the match report for the matching operation.

The details of one or more implementations are set forth in the accompanying drawings and the description below. Other potential features and advantages will become apparent from the description, the drawings, and the claims.

Other implementations of these aspects include corresponding systems, apparatus and computer programs, configured to perform the actions of the methods, encoded on computer storage devices.

### BRIEF DESCRIPTION OF THE DRAWINGS

FIG. 1A is a block diagram that illustrates an example of a system that can generate a match report for a quality-based matching operation.

FIG. 1B is a diagram that illustrates an example of a technique for generating a match report for a quality-based matching operation.

FIG. 1C is a diagram that illustrates an example of a technique for computing a search packet match score for a search package of a quality cluster.

FIG. 2A is a diagram that illustrates an example of assigning search fingerprint images of a search record to different quality clusters.

FIG. 2B is a diagram that illustrates an example of a quality-based matching operation.

FIG. 3 is a flowchart that illustrates an example of a process for computing a normalized reference match score for a reference record that is compared to a search record in a matching operation.

FIG. 4 is a block diagram of computing devices on which the processes described herein, or portions thereof, may be implemented.

In the drawings, like reference numbers represent corresponding parts throughout.

### DETAILED DESCRIPTION

In general, this document describes a system that is capable of improving the results of a matching operation by normalizing match scores with respect to quality levels of compared fingerprints and/or attributes of the compared fingerprints. The system initially obtains match data of the matching operation. The match data can include baseline record match scores for a set of reference records that are compared against a search record. The system then uses normalization techniques to normalize the values of the baseline record match scores with respect to, for example, quality levels of the search and reference records, and various attributes of the compared fingerprints, such as fingerprint quality, finger position, and detected fingerprint patterns. The normalized record match scores can therefore be used to more accurately represent the similarity between the search record and the reference records.

As discussed herein, a “pair match score” represents a score reflecting a similarity of a search fingerprint image from a search record and a reference fingerprint image from a reference record. The pair match score can be computed during a matching operation of the search record and the reference record. In some instances, the pair match score represents a similarity of two compared fingerprints of the same finger, for example, search and reference fingerprint images of a left middle finger. The value of a pair match score can represent the degree to which two fingerprints are similar, for example, local and global geometric similarities, similarities in features present within the image, number of mated minutiae, etc.

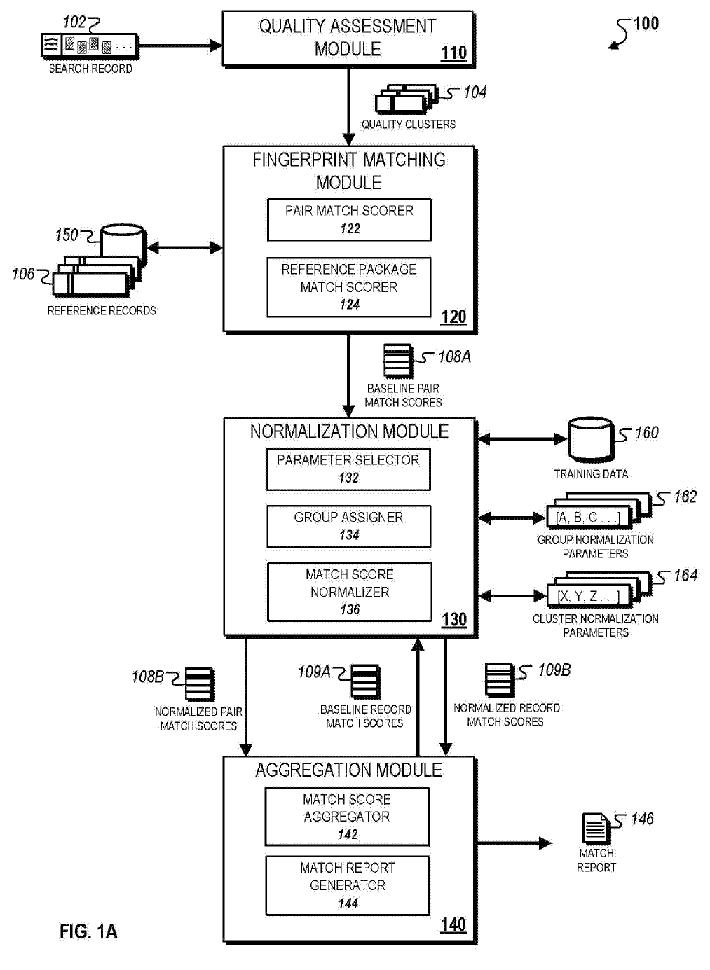

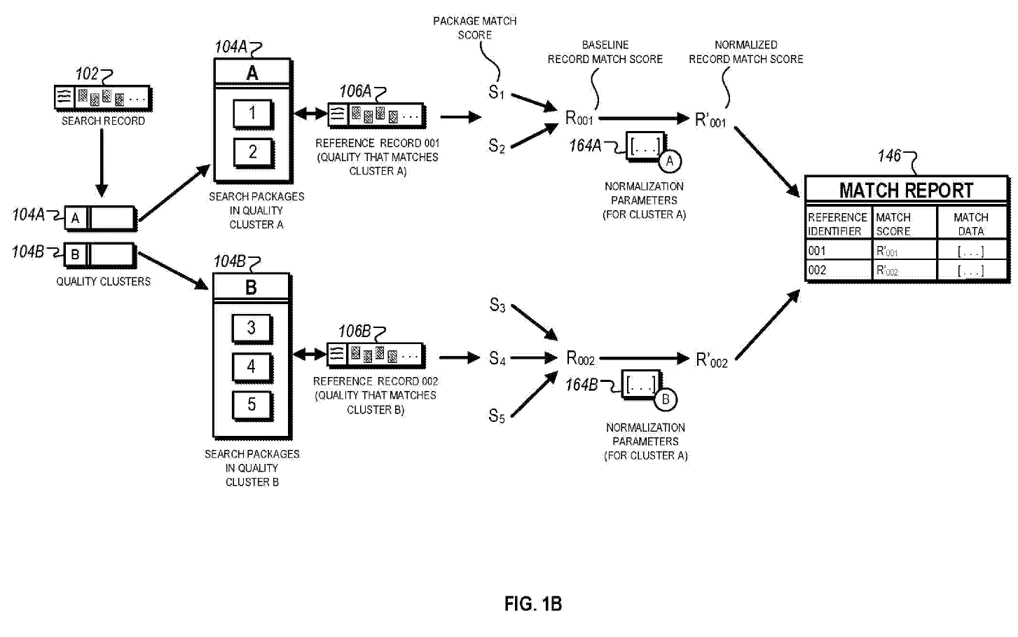

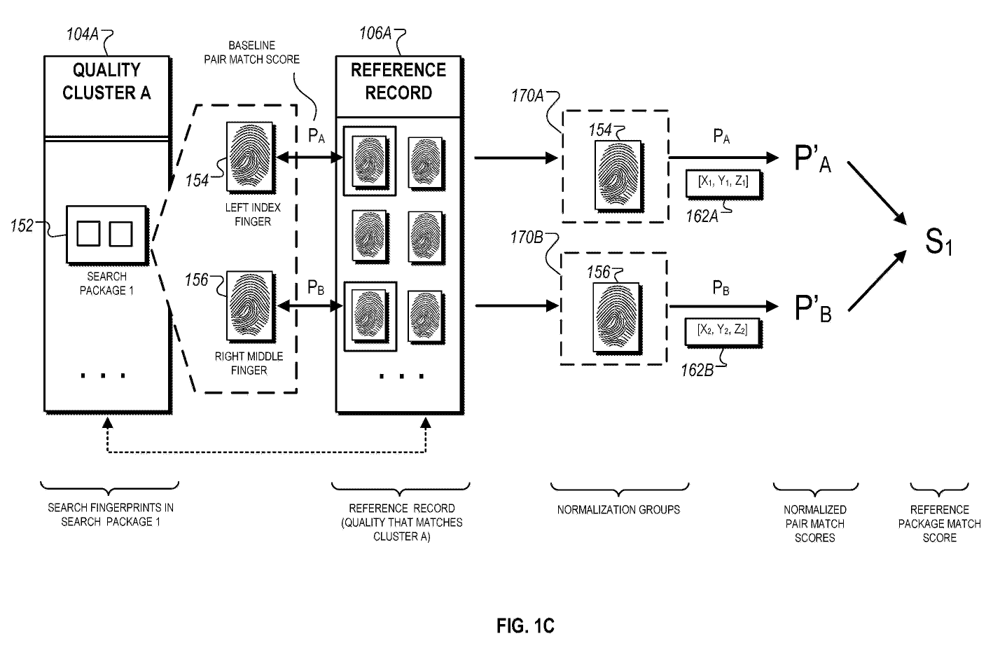

As discussed herein, a “package match score” represents an aggregate similarity of search fingerprint images within a particular search package of a quality cluster and the corresponding reference fingerprint images of a reference record that are compared to the search fingerprint images. The package match score can be computed during a matching operation of the search record and the reference record. For example, as discussed in more detail below with respect to FIG. 1C, a package match score for a particular reference fingerprint image can be computed by combining normalized pair match scores of the search fingerprint images that are included in a corresponding search package.

As discussed herein, a “record match score” represents an overall similarity of all search fingerprint images of a quality cluster and the corresponding reference fingerprint images of a reference record that are compared to each of the search fingerprint images of the quality cluster. The record match score can be computed during a matching operation for a reference record that is compared to the search packages of a particular quality cluster. For example, as discussed in more detail below with respect to FIG. 1B, a record match score for a reference record can be computed by combining the package match scores of reference fingerprint images that are compared to search fingerprint images of the search packages that are included in a quality cluster associated with the reference record, e.g., a quality cluster having the same quality level as the quality level of the reference record.

As discussed herein, a “baseline match score” represents a match score that is computed without the use of normalization parameters, which are discussed in greater detail below. For example, as shown in FIG. 1C, a baseline pair match score represents a match score that is computed based on a comparison of a search fingerprint image and a reference fingerprint image without regard to the normalization parameters associated with a normalization group. In this example, the baseline pair match score can be computed, for instance, during a matching operation of a search record and a reference record, and included in match data for the matching operation.

As another example, as shown in FIG. 1B, a baseline record match score represents a match score that is combined based on the package match scores of reference fingerprint images that are compared to search fingerprint images included in the search packages that are of a particular quality cluster without regard to the normalization parameters associated with the quality cluster. In this example, baseline record match score can be computed, for instance, during a matching operation of a search record and a reference record, and included in match data for the matching operation.

As discussed herein, a “normalized match score” represents a match score that has been a value that has been adjusted (or normalized) relative to a baseline value based on one or more factors that are expected to impact the accuracy of the match score. For example, a match score can be normalized with respect to quality level of a search fingerprint image such that the normalized score more accurately reflects similarity to a reference fingerprint image when considering the impact of the quality level of the search fingerprint image.

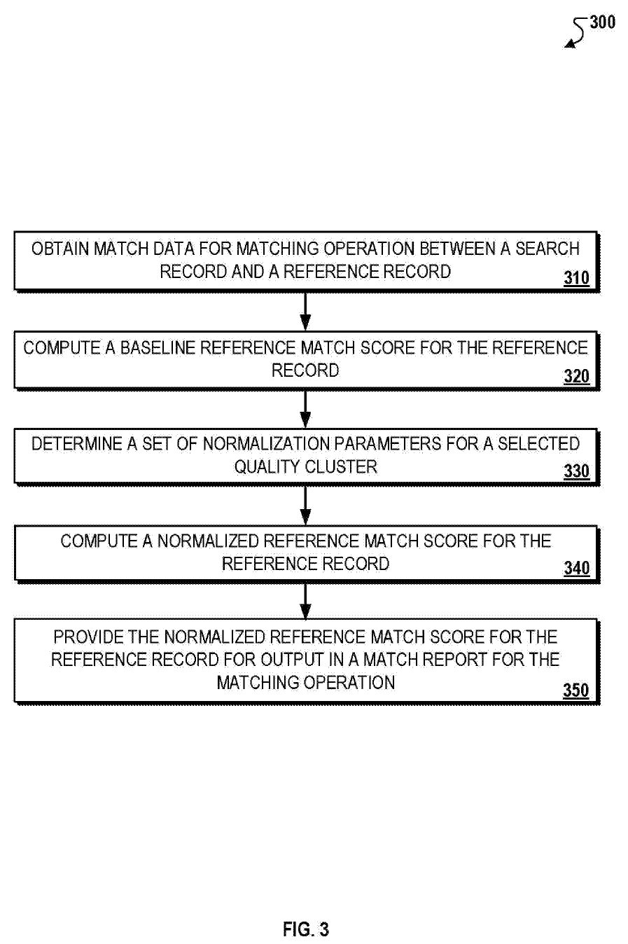

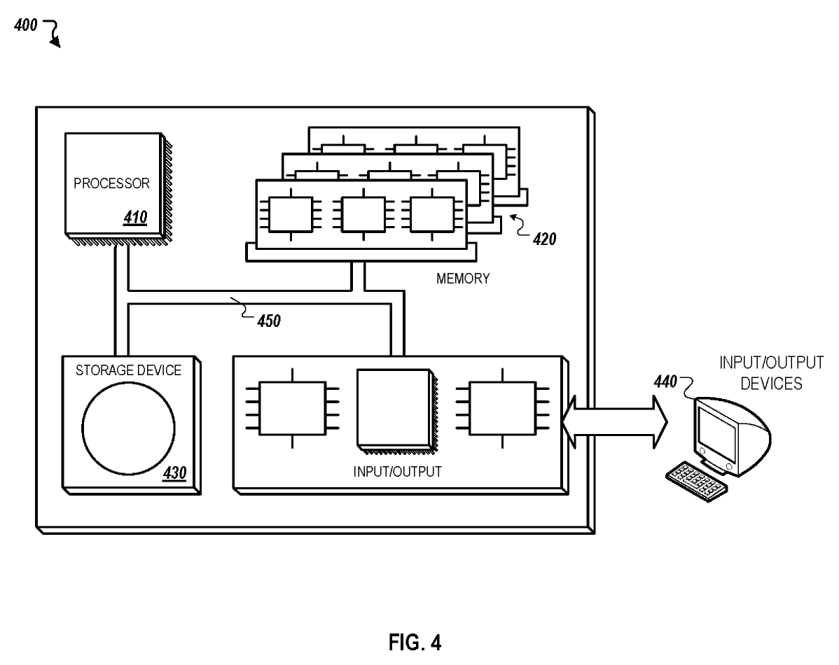

A match score can be normalized based on applying normalization parameters that represent and/or predict the impact of certain factors on the accuracy of a match score value. As discussed in more detail below in FIGS. 3 and 4, normalization parameters can be determined and/or selected based on using statistical techniques, such as applying a logistic linear regression model and/or applying a logistic regression model, on training data.

One example of a normalized match score is a normalized pair match score. This type of match score is normalized based on normalization parameters that are determined for an associated normalization group that includes a search fingerprint image. In this context, a normalization group can represent a collection of fingerprints that share a particular feature or attribute affecting a similarity determination. For instance, a normalization group can represent a set of fingerprint images that share the quality level, include a fingerprint in the same region of the image, or include similar and/or the same fingerprint patterns. Normalization parameters for a normalization group are therefore parameters that are used to normalize pair match scores based on the shared attributes that are specific to the normalization group. As depicted in FIG. 1C and discussed in more detail below, determining a normalized pair match score for a search fingerprint image involves classifying search fingerprint image as belonging to a particular normalization group, and then normalizing a baseline pair match score for the search fingerprint image using normalization parameters for the particular normalization group.

Another example of a normalized match score is a normalized record match score. This type of match score is normalized based on normalization parameters that are determined for a particular quality cluster. In this example, the normalization parameters can be selected based on training data of matching and non-matching reference record scores of the quality cluster. As depicted in FIG. 1B and discussed in more detail below, determining a normalized record match score for a reference record involves determining normalization parameters for a quality cluster that is associated with the reference record, and then normalizing a baseline record match score for the reference record using the normalization parameters for the quality cluster.

FIG. 1A is a block diagram that illustrates an example of a system 100 that can generate a match report for a quality-based matching operation. The system 100 generally includes a quality assessment module 110, a fingerprint matching module 120, a normalization module 130, an aggregation module 140, a record repository 150, and a training repository 160. The fingerprint matching module 120 further includes a pair match scorer 122. The normalization module 130 further includes a parameter selector 132, a group assigner 134, and a match score normalizer 136. The aggregation module 140 further includes a package match scorer 142, match score aggregator 144 and a match report generator 146.

In general, the system 100 can represent any type of automated fingerprint identification system (AFIS) that is capable of comparing search fingerprint images included within a search record 102 and reference fingerprint images included within reference records 106 stored within the repository 150. For example,

The components of the system 100 can be software modules that are implemented on, for example, a server system with one or processors for performing operations stored on a suitable computer-readable medium. The components of the system 100 can be implemented on a common software application, or alternatively, on logically distinct software applications. Additionally, the components can of the system 100 can be implemented on a single server system, or alternatively, on multiple server systems that are configured to exchange communications with each other through a suitable network medium.

The system 100 can perform a matching operation that compares search fingerprint images within a search record 102 and reference fingerprint images within reference records 106. As discussed in more detail below, the system 100 performs the matching operation in a manner such that search fingerprint images of different quality levels are compared against reference fingerprint levels of comparable or greater quality levels to, for instance, improve the accuracy of the fingerprint images by reducing errors due to impacts of quality levels of the search fingerprint images.

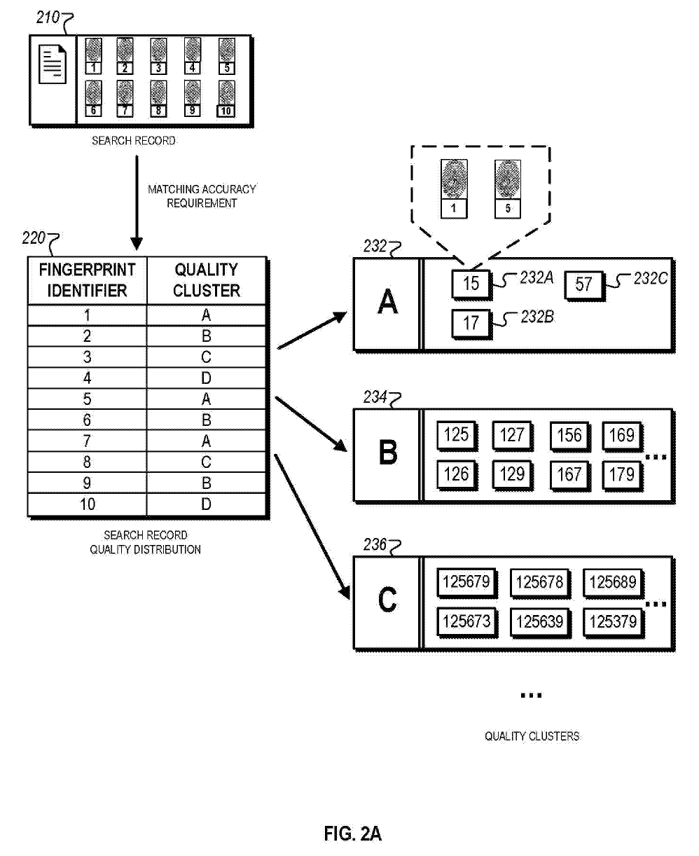

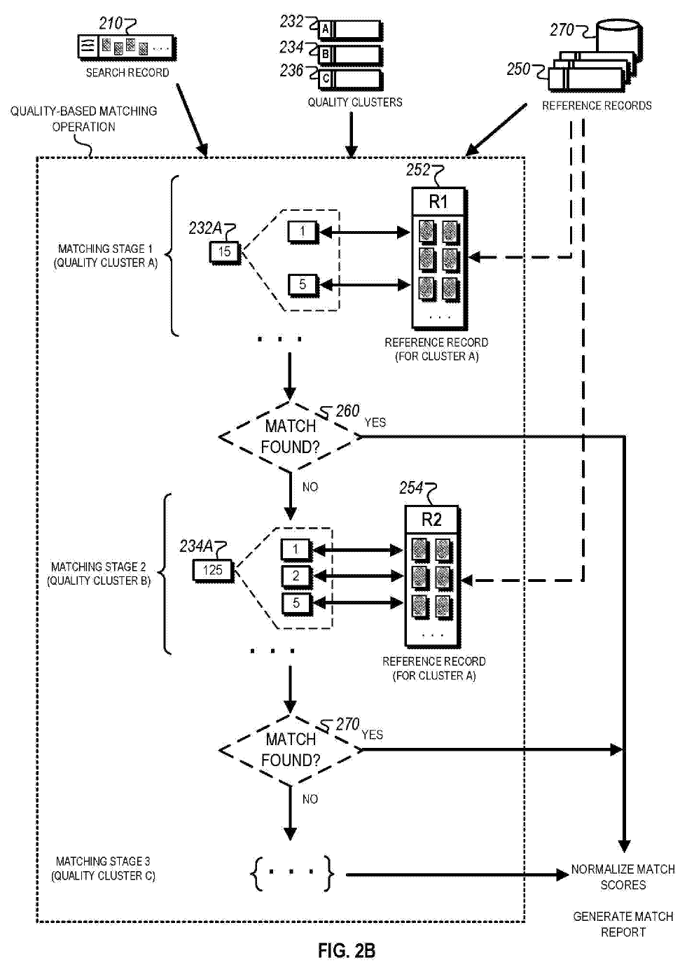

The quality assessment module 110 determines a quality level for each of the search fingerprint images included in the search record 102 and generates quality clusters 104 that are each associated with a different quality level. Each quality cluster includes one or more search packages that are generated based on a matching accuracy requirement of the matching operation, as depicted in FIG. 2A and discussed in detail below.

The quality assessment module 110 re-organizes the search fingerprint images of the search record 102 into quality clusters based on a matching accuracy requirement and quality levels of the search fingerprint images as specified in the search record 102. Alternatively, in some implementations, the quality levels of search fingerprint images of the search record 102 are not specified within the quality search record, and are computed by the quality assessment module 110 using one or more image quality assessment techniques to derive the quality level of the search fingerprint images according to a set of predefined quality criteria for the matching operation to be performed by the fingerprint matching module 120.

To re-organize and classify the search fingerprint images based on their quality levels, the quality assessment module 110 generates search packages for one or more the quality clusters 104 based on the match accuracy requirement. The quality assessment module 110 then assigns search fingerprint images to each of the search packages to permit quality-based matching. An example of re-organizing and classifying search fingerprint images into different quality clusters is depicted in FIG. 2A. Once re-organized and classified, the quality clusters 104, each of which are associated with search packages and search fingerprint images associated to the search packages, are provide to the fingerprint matching module 120 for use when conducting a matching operation.

The fingerprint matching module 120 performs a matching operation that compares the search record 102 and one or more of the reference records 106 to generate match data for the matching operation. An example of a matching operation conducted by the fingerprint matching module 120 is depicted in FIG. 2B. In this example, the fingerprint matching module 120 re-organizes search fingerprint images in the search record 210 into search packages of different quality clusters based on quality levels of the search fingerprint images and a matching accuracy requirement for the matching operation.

The fingerprint matching module 120 generates match data for the conducted matching operation. The match data can identify search fingerprint images within the search record 102, and one or more attributes of each of the search fingerprint images. Examples of such attributes include a finger type of the fingerprint included in a search fingerprint image, a location of the fingerprint within the search fingerprint, or a quality level of the search fingerprint image. Other examples of attributes can include features detected within a search fingerprint image, such as minutiae detected within the search fingerprint.

The match data can also identify hierarchal classifications or organizations that are conducted by the fingerprint matching module 120 when performing the matching operation. For example, the matching data can identify the quality cluster that each search fingerprint image is assigned to, and in particular, the composition of the search packages, e.g., the search fingerprint images that are included in each search image. In this context, the match data can also identify the search packages that are identified and generated for each quality cluster based on applying a match accuracy requirement for the matching operation to the quality levels of the search fingerprint images of the search record 102. Examples of such classifications and assignments are depicted in FIG. 2A.

The pair match scorer 122 computes baseline pair match scores 108A based on performing the matching operation as discussed above. Specifically, the fingerprint matching module 120 compares search fingerprint images and corresponding reference fingerprint images within the reference records 106 and computes the baseline pair match scores 108A based on the comparison. As discussed above, each score within the baseline pair match scores 108A represents a determined similarity between a search fingerprint image and a corresponding reference fingerprint image that is compared to the search fingerprint image by the fingerprint matching module 120.

The normalization module 130 performs various techniques for normalizing match scores based on applying a set of given normalization parameters. The normalization module 130 generally performs two types of score normalizations, as discussed herein, although in some implementations, the normalization module 130 can also explicitly or implicitly perform other types of score normalization, such as multimodal biometric fusion. In such implementations, the normalization module 130 can use different types of fusion methods, such as likelihood ratio-based fusion, false-acceptance-rate (FAR), or linear fusion.

The first example of score normalization performed by the normalization module 130 involves normalizing the baseline pair match scores 108A to compute normalized pair match scores. This technique can be performed on a search package basis, e.g., normalized pair match scores for search fingerprint images included in a particular search package normalized together. The descriptions below focus on the normalization of pair match scores for search fingerprint images of a single search package for brevity and simplicity.

To normalize the baseline pair match scores of the search fingerprint images included in a search package, the group assigner 134 initially assigns categorizes each search fingerprint image as belonging to a particular normalization group. The assignment can be based on attributes of each search fingerprint image, such as fingerprint location within the image, a finger type of the fingerprint in the image, feature patterns detected in the image, etc.

The parameter selector 132 determines the normalization parameters for each of the normalization groups. For example, the parameter selector 132 selects normalization parameters for a particular normalization group based on comparing the attributes of the normalization group to a set of predefined normalization groups with known attributes and associated normalization parameters.

In this example, the parameter selector 132 can use statistical techniques, such as applying a regression model, to identify the predetermined normalization group that best matches the normalization group and select the normalization parameters of the predetermined normalization group as the normalization parameters of the normalization group.

In particular, the parameter selector 132 performs ten-print to ten-print matching on fingerprint images of the training data 160 using the fingerprint matching module 120. The parameter selector 132 then obtains match results with respect to a single finger, e.g., left index finger. The match data identifies a number of mated fingerprints, a number of non-mated fingerprints. The match data also identifies the following for each fingerprint: original match score, fingerprint quality, finger position, and search fingerprint pattern.

The parameter selector 132 assign the match results into different normalization groups based on the fingerprint quality, finger position, and search fingerprint pattern, as discussed above. The parameter selector 132 then verifies that each normalization group has a sufficient number of mated and non-mated fingerprints. If one of the normalization groups does not have a sufficient number of mated or non-mated fingerprints, then the parameter selector 132 instructs the fingerprint matching module 132 to conduct additional matching.

Once each normalization group is determined to have a sufficient number of mated and non-mated fingerprints, the parameter selector 132 uses the following logistic regression to fit a likelihood ratio against the original scores for each group:

$$log \frac{1 - P ( M \vert x )}{P ( NM \vert x )} = {θ}_{0} + {θ}_{1} x$$

where M represents mated fingerprints, NM represents unmated fingerprint pairs, x represents an original match score.

The parameter selector 132 then determines normalization parameters, e.g., aθ₀, aθ₁) for each normalization group. The normalization parameters are determined proportionally to the regression parameters (θ₀, θ₁) depending on a desired final match score range.

The normalization method discussed above can improve or at least maintain the overall accuracy of fingerprint matching. However, since all matching cases are divided into groups based on quality, fingerprint position, fingerprint pattern, etc., and likelihood-ratio based method is used for score normalization in each group, when a fixed FAR threshold is used, there can sometimes be trade-offs among groups in true-acceptance rate (TAR). Since the system 100 can be calibrated for different quality clusters, it might be desired that the accuracy for each quality cluster still be maintained after the normalization. The normalization module 130 therefore performs a second type of score normalization with respect to each quality cluster, as discussed below.

The second example of score normalization performed by the normalization module 130 involves normalizing the record match scores 109A to compute normalized record match scores 109B. This technique can be performed on a quality cluster basis, e.g., baseline record match scores are normalized based on selecting different normalization parameters for each quality cluster.

The normalization parameters for the different quality clusters can be obtained from the training data 160 using a FAR-based method. In particular, the parameter selector 132 can obtain record match scores of non-mated fingerprints in each quality cluster for training. The parameter selector 132 then applies the following linear regression to fit the log(FAR) against the baseline record match score:

−log(FAR)=θ₀+θ₁y

The parameter selector 132 then determines normalization parameters for each quality cluster proportionally to the regression parameters depending on the desired final output score range.

The group assigner 134 assigns search fingerprint images within a particular quality cluster to a normalization group from among multiple normalization groups. As discussed above, each normalization group can represent a set of search fingerprint images that share a particular attribute and/or feature. For example, the group assigner 134 can assign each search fingerprint image within the quality cluster to a normalization group based on the finger type of the fingerprint included in the image, a location of a fingerprint within the image, features extracted for the fingerprint within the image, the quality level of the image, among others. In the example depicted in FIG. 1B, search fingerprint images 154 and 156 of the quality cluster 104A are each assigned to a different normalization group, such as normalization groups 170A and 170B.

The match score normalizer 136 applies the normalized parameters selected by the parameter selector 132 to adjust baseline match scores to compute normalized scores. As discussed above, the match score normalizer 136 can normalize two types of baseline match scores.

The first type of match score that is normalized by the match score normalizer 136 is a baseline pair match score that represents a similarity between individual search and reference fingerprint images. To normalize these types of baseline match scores, the match score normalizer 136 applies group normalization parameters 162 to the baseline pair match scores in order to generate normalized pair match scores. The normalization parameters 162 include different normalization parameters for each normalization group to which individual search fingerprint images of a quality cluster are assigned to by the group assigner 134.

For example, as shown in FIG. 1C, normalization parameters 162A correspond to the normalization group 170A whereas the normalization parameters 162B correspond to the normalization group 170B. In this example, the match score normalizer 136 applies normalization parameters 162A to the baseline pair match score “P_{A}” for the search fingerprint image 154 in order to compute the normalized pair match score “P′_{A}” for the search fingerprint image 154. Additionally, the match score normalizer 136 applies normalization parameters 162B to the baseline pair match score “P_{B}” for the search fingerprint image 156 in order to compute the normalized pair match score “P′_{B}” for the search fingerprint image 156.

The second type of match score that is normalized by the match score normalizer 136 is a baseline record match score that represents an overall similarity between search fingerprint images of a particular quality cluster and corresponding reference fingerprint images of a reference record having a quality level that matches the quality level of the quality cluster, e.g., the baseline record match scores 109A. To normalize the baseline record match scores 109A, the match score normalizer 136 applies group normalization parameters 164 to the baseline record match scores 109A in order to generate the normalized record match scores 109B. The normalization parameters 164 include different normalization parameters for a different quality cluster to which individual search fingerprint images are assigned and are associated with the reference records 106.

For example, as shown in FIG. 1B, normalization parameters 164A correspond to the quality cluster 104A whereas the normalization parameters 164B correspond to the quality cluster 104B. In this example, the match score normalizer 136 applies normalization parameters 164A to the baseline record match score “R₀₀₁” for the reference record 106A in order to compute the normalized record match score “R′₀₀₁” for the reference record 106A. Additionally, the match score normalizer 136 applies normalization parameters 164B to the baseline record match score “R₀₀₂” for the reference record 104B in order to compute the normalized pair match score “R′₀₀₂” for the reference record 104B.

The aggregation module 140 generally combines individual match scores to compute aggregate scores. For example, as shown in FIG. 1C, the match score aggregator 142 can combine pair normalized match scores “P′_{A}” and “P′_{B}” for the search fingerprint images 154 and 156 matched with the corresponding reference fingerprints of the reference package, respectively, to generate the package match score “S₁” for a reference fingerprint image that is compared to search fingerprint images included in the search package 152 of the quality cluster 104A. As another example, as shown in FIG. 1B, the match score 142 of FIG. 1A can be computed by combining package match scores “S₁” and “S₂” of reference fingerprint images compared against search fingerprint images of the search packages “1” and “2” within the quality cluster 104A. The package match scores can then be combined to compute a record match score for the reference record 106A. The reference record 106A is associated with the quality cluster 104A and compared against search fingerprint images included in the two search packages of the quality cluster 104A. In this regard, the match score aggregator 142 aggregates match scores at the package level as well as the quality cluster level in relation to the normalization operations performed by the normalization module 130.

The aggregation module 140 also generates a match report 146 once the baseline record match scores 109A have been normalized as the normalized record match scores 109B by the match score normalizer 136 of the normalization module 130. The match report 146 can include a list of reference records from the reference records 106 that were compared to the search record 102 during the matching operation performed by the fingerprint matching module 120. For example, the match report 146 can include a list of reference record identifiers and a corresponding normalized record match score for each identifier. The list can be sorted such that the reference record identifiers with the highest normalized record scores (e.g., corresponding to reference records that are most likely to represent match candidates for the search record 102) appear on the top of the list.

In some implementations, the match report 146 can include associated match data, such as match data for reference fingerprints included in the reference record and compared against search fingerprint images of the search record. In such implementations, the match report 146 can additionally include intermediate match scores that were computed in the process of finally computing the normalized record match scores 109B, such as the normalized pair match scores 108B and the search packet match scores. For example, the match report 146 can include a row corresponding to each reference record that was compared against the search record. In this example, the match report can include columns for the reference record, such as reference identifier, quality level, reference fingerprints compared to search fingerprints, pair match scores (baseline and normalized), and record match score (baseline and normalized). In some instances, the match report 146 can also identify attributes of the reference fingerprint images, which are compared to the attributes of the search fingerprint images to determine similarity.

FIG. 1B is a diagram that illustrates an example of a technique for generating a match report for a quality-based matching operation. The techniques depicted in the figure can be performed by components of the system 100 as discussed above in reference to FIG. 1A.

In the example depicted, two reference records, reference records 106A and 106B, are compared to the search record 102 during a matching operation. The reference records 106A and 106B are each associated with a different quality level that correspond to two quality clusters, quality clusters 104A and 104B, that are used to organize and classify search fingerprint images within the search record 102 as discussed above. A normalized match score is computed for each of the reference records 106A and 106B and included in the match report 146.

As shown in FIG. 1B, search fingerprint images of the search record 102 are initially re-organized and classified into quality clusters 104A and 104B. In this example, quality cluster 104A can represent a quality cluster associated with a higher quality level than that of the quality cluster 104B. The search fingerprint images are organized into search packages of the quality clusters 104A and 104B based on a match accuracy requirement of the matching operation and the quality levels of the search fingerprint images of the search record 102. In the example depicted in FIG. 1B, the quality cluster 104A is assigned two search packages, e.g., search packages “1” and “2,” and the quality cluster 104B is assigned three search packages, e.g., search packages “3,” “4” and “5.” Each package can have two or more search fingerprint images, based on the quality distribution of the search fingerprint images in relation to the match accuracy requirement. For example, the search packages of the quality cluster 104A can include two search fingerprint images each, while the search packages of the quality cluster 104B can include three search fingerprint images each.

The search fingerprint images assigned to the search packages of each quality cluster are then compared to corresponding reference fingerprint images of a reference record having a corresponding quality level. In the example depicted in FIG. 1B, the search fingerprint images included in the quality cluster 104A are compared to corresponding reference fingerprint images of the reference record 106A, whereas the search fingerprint images included in the quality cluster 104B are compared to corresponding reference fingerprint images of the reference record 106B. The comparisons can be performed on a search package basis such that pair match scores are computed and normalized for each search package, as shown in more detail in FIG. 1B.

The normalized pair match scores for the search fingerprints in each search package are then combined to generate a package match score for each reference package that is compared to the search packages of the quality cluster 104A. For example, two package match scores, “S₁” and “S₂,” are obtained by matching fingerprints of search packages “1” and “2,” included in the quality cluster 104A, with fingerprints of reference packages of the reference record 106A compared against the search packages. Additionally, package match scores, “S₃,” “S₆,” and “S₆,” are obtained by matching fingerprints of search packages “3,” “4,” and “5,” included in the quality cluster 104B with corresponding reference fingerprint images of the reference record 106A. The package match scores are then combined to compute a baseline record match score for each reference record. For example, the package match scores “S₁” and “S₂” are combined to compute the baseline record match score “R₀₀₁” for the reference record 106A. In this example, because the reference record 106A has an overall quality level that corresponds to the quality level of the quality cluster 104A, the baseline record match score “R₀₀₁” can represent an aggregate similarity of the search fingerprint images included in the quality cluster 104A and the corresponding reference fingerprint images of the reference record 106A. Additionally, the package match scores “S₃,” “S₄,” and “S₅” are combined to compute the baseline record match score “R₀₀₂” for the reference record 106B.

The baseline record match scores for the reference records 106A and 106B are normalized using normalization parameters that are specific to the corresponding quality clusters of the reference records. For example, the normalization parameters 164A are selected for the quality cluster 104A and therefore applied to the baseline record match score “R₀₀₁” to compute a normalized record match score “R′₀₀₁” for the reference record 106A. Additionally, the normalization parameters 164B are selected for the quality cluster 104B and therefore applied to the baseline record match score “R₀₀₂” to compute a normalized record match score “R′₀₀₂” for the reference record 106B. As discussed above, the normalized record match scores reflect adjusted match scores that account for factors associated with a quality level of a particular quality cluster that can affect the similarity determination for a comparison of search and reference records.

The normalized match scores for the reference records 106A and 106B are aggregated and included in the match report 146. In the example depicted in FIG. 1B, the match report 146 includes columns for “reference identifier,” “match score,” and “match data.” The “reference identifier” column identifies each reference record compared to the search record 102, e.g., the reference records 106A and 106B, the “match scores” column identifies the normalized record match scores for the reference records 106A and 106B, e.g., “R′₀₀₁” and “R′₀₀₂,” and the “match data” column includes data generated during the matching operation, e.g., pair match scores, package match scores, number of mated fingerprints, number of non-mated fingerprints, etc. As discussed herein, a mated fingerprint represents a search fingerprint that is determined to have a corresponding reference fingerprint within the reference record, e.g., a reference fingerprint that is predicted to be the same fingerprint as the search fingerprint. A non-mated fingerprint therefore represents a search fingerprint that does not have a corresponding reference fingerprint in the reference record.

FIG. 1C is a diagram that illustrates an example of a technique for computing a search packet match score for a search package of a quality cluster. The techniques depicted in the figure can be performed by components of the system 100 as discussed above in reference to FIG. 1A.

In the example depicted, the quality cluster 104A that is depicted in FIG. 1B includes a search package 152. FIG. 1C illustrates the computation of a single search package score for simplicity, although the quality cluster 104A can include additional search packages. The search package 152, in this example, includes two search fingerprint images, e.g., search fingerprint images 154 and 156.

Each search fingerprint image within the search package 152 is compared to a corresponding reference fingerprint image in the reference record 106A to compute a baseline pair match score representing a similarity between the search fingerprint image and the compared reference fingerprint image. For example, the baseline pair match scores “P_{A}” and “P_{B}” are computed for the search fingerprint images 154 and 156.

The baseline pair match scores for the search fingerprint images 154 and 156 are then normalized to compute normalized pair match scores “‘P’_{A}” and “P′_{B}” for the search fingerprint images 154 and 156, respectively. To normalize the baseline pair scores, the search fingerprint images 154A and 156A are initially assigned to a normalization group from among multiple organization groups that are associated with different fingerprint attributes. As discussed above, the search fingerprint images 154 and 156 can be assigned to the normalization group based on, for example, a finger type of the fingerprint within in the search fingerprint image, a location of the fingerprint within the search fingerprint image, detected patterns of the fingerprint within the image, or a quality level of the search fingerprint image. In the example depicted in FIG. 1C, the search fingerprint images 154 and 156 are classified as belonging to different normalization groups because they each include a fingerprint of a different finger type. For example, the search fingerprint image 154 is classified as belonging to the normalization group for index finger type, whereas the search fingerprint image 156 is classified as belong to the normalization group for middle finger type.

The baseline pair match scores for the search fingerprint images 154 and 156 are normalized based on normalization parameters that are selected and/or determined for each normalization group. For example, the normalization parameters 162A are selected for the normalization group for 170A and the normalization parameters 162A are selected for the normalization group 170B. The selected normalization parameters are applied to the corresponding baseline pair match scores to compute normalized pair match scores. For example, the normalization parameters 162A are applied to the baseline pair match score “P_{A}” to compute a normalized pair match score “P′_{A}” and the normalization parameters 162B are applied to the baseline pair match score “P_{B}” to compute a normalized pair match score “P′_{B}.”

The normalized baseline pair match scores for the search fingerprint images 154 and 156 are then combined to generate a package match score for reference fingerprints that are compared to search fingerprints included in the search package 152. As discussed above, the package match score represents an aggregate similarity between the search fingerprint images within a search package, e.g., search fingerprint images 154 and 156, and corresponding reference fingerprint images that are compared to the search fingerprint images, e.g., reference fingerprint images of the reference record 106A.

FIG. 2A is a diagram that illustrates an example of assigning search fingerprint images of a search record 210 to different quality clusters 232, 234, and 236. In this example, the search record 210 is a search record that includes search fingerprint images for each finger of an individual. The search record 210, in this example, also includes associated information, such as personally identifiable information for an individual whose fingers are captured in the search fingerprint images, capture information for the search fingerprint images, or notes submitted by a latent examiner analyzing a prior matching operation using the search record.

Each search fingerprint image within the search record 210 is associated with a quality level. In this example, individual search fingerprint images are associated with different quality levels due to, for example, capture errors when collecting fingerprints of different fingers, distortions in the collected fingerprints, partially collected fingerprints of certain fingers, or uneven lighting conditions during image capture, among other. The different quality levels of the search fingerprint images are included in a table 220 representing a quality distribution of the search record 210. In this example, quality level “A” represents the highest quality search fingerprint images, and quality level “D” represents the lowest quality search fingerprint images.

The search fingerprint images within the search record 210 are then re-organized into search packages of quality clusters based on an accuracy requirement. The accuracy requirement can be used to determine the number of fingerprint matches at different quality levels to achieve a desired identification rate, e.g., 98.5%, with the use of an accuracy table. One example of an accuracy metric that is used by the National Institute of Standards and Technology (NIST), is included below:

| | Number Fingers | | | |
|---|---|---|---|---|
| | 1 | 2 | 3 | 4 |
| | A quality prints search against A quality prints | | | |
| Identification | 98.5% | 99.5% | 99.9% | 99.99% |
| Rate | | | | |
| | >=B quality prints (B match B, B match A) | | | |
| Identification | 92.5% | 98.8% | 99.5% | 99.8% |
| Rate | | | | |
| | >=C quality prints (C match C, C match B, C match A) | | | |
| Identification | 85.5% | 93.3% | 95.5% | 98.8% |
| Rate | | | | |

The accuracy table can be used to determine the number of search packages to generate within each quality cluster, and the number of search fingerprint images to include in each search package of each quality cluster. The use of search packages to perform matching, as opposed to performing the search using all ten fingerprint images, results in increased speed and efficiency because, identifying a sufficient number of matches with high quality fingerprint images can be used to terminate the matching operation without requiring matching of lower quality fingerprint images. For example, under the accuracy table above, if an AFIS identifies matches for two search fingerprint images of quality level “A,” then a matching requirement of “99.5” can be met without having to match, for example, other search fingerprint images of quality levels “B,” “C,” and “D.”

To permit quality-based matching of the search fingerprint images, as discussed above, search fingerprint images can be re-organized and placed in search packages of different quality clusters so that reference fingerprint images of a reference record of a certain quality level are only matched against search fingerprint images of an equal or greater quality level. To achieve this, search packages for quality clusters 232, 234, and 235 are formed as follows:

Quality Cluster 232: include search fingerprint images with quality level “A” only

Quality Cluster 234: include search fingerprint images with quality level “B” or greater

Quality Cluster 236: include search fingerprint images with quality level “C” or greater

To achieve a desired accuracy of “99.5,” as is the case with the example depicted in FIG. 2A, matches for two fingerprint images of quality level “A” are needed to achieve the match accuracy requirement. Additionally, the table 220 indicates that there are three search fingerprint images with this level, e.g., “1,” “5,” and “7.” The search packages formed for the quality cluster 232 therefore must include two search fingerprint images in each search package, and the total number of search packages is three packages,” e.g., a first search package including images “1” and “5,” a second search package including images “1” and “7,” and a third search package including images “5” and “7.” Three search packages 232A, 232B, and 232C are therefore generated for the quality cluster 232 to meet the match accuracy requirement of “99.5.” A similar technique can be used to generate search packages for the other quality clusters 234 and 236.

FIG. 2B is a diagram that illustrates an example of a quality-based matching operation. The depicted matched operation can be performed by the fingerprint matching module 120 in relation to the match score normalization techniques discussed throughout this document. As discussed above, the matching operation can be performed according to re-organizing and classifying search fingerprint images of a search record into search packages to ensure that reference fingerprint images of a reference record of a certain quality level are matched against search fingerprint images of the equal or greater quality level. In addition, the matching operation can be performed incrementally, e.g., search fingerprint images assigned to the highest quality level at matched prior to matching lower quality fingerprint images so that if a requisite number of matches to meet an accuracy requirement are identified within the highest quality images, then the system can terminate the matching operation, thereby improving the speed in performing a matching operation and reducing the computational resources that are needed to perform a single matching operation.

As shown in FIG. 1, the matching operation is initiated by re-organizing search fingerprint images of the search record 210 into search packages of quality clusters 232, 234, and 236 that are each associated with different quality levels. Once organized into search packages of the quality clusters 232, 234, and 236, the fingerprint matching module 120 then starts a first matching stage whereby search fingerprint images within the quality cluster 232 are compared against corresponding reference fingerprint images of a reference record 252 from among reference records 250 stored within a repository 270. As an example, a search package 232A, which includes search fingerprint images “1” and “2” are compared against corresponding reference fingerprints of the same type within the reference record 252. The matching is repeated for all other search packages within the quality cluster 232 and then the fingerprint matching module 120 proceeds to step 260.

At step 260, the fingerprint matching module 120 determines if a match has been found within the search packages of the quality cluster 232. For example, as discussed above with respect to FIG. 1B, if a match accuracy requirement is set to “99.5%,” then two fingerprint matches are needed in the first matching stage to determine if a match has been found in step 260. If a match has been found at step 260, e.g., two search fingerprint images are identified as matching corresponding reference fingerprint images in the reference record 252, then the fingerprint matching module 120 determines that no further matching is needed since the match results of the first stage matching are sufficient to satisfy the accuracy requirement of the matching operation.

Alternatively, if a match has not been found at step 260, then the fingerprint matching module 120 proceeds to a second stage of matching where search fingerprint images within the quality cluster 234 are compared against a reference record 254 that has a quality level that matches, or is similar to, the quality level associated with the quality cluster 234. As an example, a search package 234A, which includes search fingerprint images “1,” “2,” and “5” are compared against corresponding reference fingerprints of the same type within the reference record 254. The matching is repeated for all other search packages within the quality cluster 234 and then the fingerprint matching module 120 proceeds to step 260.

At step 260, the fingerprint matching module 120 determines if a match has been found within the search packages of the quality cluster 234 is a similar manner as discussed above with respect to step 260. If a match has been found at step 270, then the fingerprint matching module 120 determines that no further matching is needed since the match results of the second stage matching are sufficient to satisfy the accuracy requirement of the matching operation. Alternatively, if a match has not been found at step 270, then the fingerprint matching module 120 proceeds to third stage matching using the search fingerprint images included in the quality cluster 236. The matching at this stage is performed in a similar manner as discussed above with respect to the first and second stages.

FIG. 3 is a flowchart that illustrates an example of a process 300 for computing a normalized reference match score for a reference record that is compared to a search record in a matching operation. Briefly, the process 300 can include obtaining match data for a matching operation between a search record and a reference record (310), computing a baseline reference match score for the reference record (320), determining a set of normalization parameters for a selected quality cluster (330), computing a normalized reference match score for the reference record (340), and providing the normalized reference match score for the reference record for output in a match report for the matching operation (350).

The process 300 is described below in reference to the system 100, although any AFIS can perform the operations of the process 300. For example, an AFIS that compares search and reference records based on using a quality-based matching technique may be capable of performing the operations of the process 300.

Additionally, one or more components of the system 100 can independently, or communicatively, perform individual operations of the process 300. For example, the quality assessment module 110 can re-organize and classify search fingerprints of the search record 102 into the quality clusters 104, the fingerprint matching module 120 can perform a matching operation, and the normalization and aggregation modules 130 and 140 can normalize baseline match scores of match data generated by the fingerprint matching module 120 while performing the matching operation.

The process 300 can include the operation of obtaining match data for a matching operation between a search record and a reference record (310). For example, as discussed in FIG. 1A, the aggregation module 140 can obtain match data for a matching operation performed by the fingerprint matching module 120. The matching operation can be a quality-based matching operation, such as the matching operation depicted in FIG. 2B.

The match data identifies various types of data and information associated with the matching operation. In the example depicted in FIG. 1A, the match data identifies search fingerprint images included within the search record 102. The match data also includes one or more attributes of each of the search fingerprint images. Examples of such attributes of a search fingerprint image can include a fingerprint location within the image, a finger type of the fingerprint within the image, fingerprint features extracted from the image, among others. The match data can also identify a selected quality cluster from among the quality clusters 104 that is associated with the search record 102 by the quality assessment module 110. For example, the selected quality cluster can represent the quality cluster with the highest quality level for achieving a matching accuracy requirement, e.g., quality cluster 232 in the example depicted in FIG. 2A. As discussed above, the quality cluster includes one or more search packages that each represent a different subset of the search fingerprint images. In the example depicted in FIG. 2A, the quality cluster 232 includes search packages 232A, 232B and 232C. Search package 232A, in particular, includes search fingerprint images “1” and “5” from the search record 210.

The process 300 can include the operation of computing a baseline reference match score for the reference record (320). For example, the aggregation module 140 can compute a baseline reference match score for a particular reference record from the reference records 106 that is compared to the search record 106. As shown in FIG. 1B, the baseline record match score is computed by combining the package match scores of reference fingerprint images that are compared to search fingerprint images of the search package that is included in a quality cluster associated with the reference record, e.g., a quality cluster having a quality level that matches the quality level of the reference record. In the example depicted in FIG. 1B, the aggregation module 140 computes a baseline record match score “R₀₀₁” for the reference record 106A based on combining the package match scores “S₁” and “S₂” of fingerprints“1” and “2” included in the quality cluster 104A.

The process 300 can include the operation of determining a set of normalization parameters for a selected quality cluster (330). For example, the normalization module 130 can determine cluster normalization parameters 164 for the selected quality cluster. As discussed above, the cluster normalization parameters 164 include different normalization parameters for each quality cluster include in the quality cluster 104. The cluster normalization parameters 164 are used to adjust the baseline record match score of a reference record to normalize its value with respect to factors of the quality level of the selected quality clusters. As discussed above, the normalization parameters for each quality cluster can be obtained by the parameter selector 132 by applying a FAR-based method on the training data 160 using the non-mated record match scores of the quality cluster.

The process 300 can include the operation of computing a normalized reference match score for the reference record (340). For example, the normalization module 130 can compute normalized record match scores 109B based on applying the cluster normalization parameters 164 to the baseline record match scores 108A computed by the aggregation module 109A. As discussed above, each quality cluster is associated with a different set of normalization parameters such that their application in the normalization process adjusts the value of a baseline record match score for a particular reference record based on its quality level.

The process 300 can include the operation of providing the normalized reference match score for the reference record for output in a match report for the matching operation (350). For example, the aggregation module 140 can provide the normalized reference match scores 109B for the reference records 106 for output in the match report 146 for the matching operation performed by the fingerprint matching module 120. As discussed above, the match report 146 can include a sorted list of the normalized record match scores 109B for the reference records 106, which then indicates the reference records that have the highest likelihood of representing a match candidate for the search record 102.

In some implementations, prior to generating the match report 146, the match report generator 144 compares the values of the normalized record match scores 109B and removes the normalized record match scores that do not satisfy the threshold value from the match report 146. In such implementations, the match report 146 only includes, for example, match data for the best-matched reference records, e.g., reference records that are determined to have the highest normalized record match scores based on satisfying the threshold value. In various instances, the threshold value can be adjusted based on, the number of reference records that are compared to the search record 102, the match accuracy requirement for the matching operation, quality levels of the search fingerprint images within the search record 102, and/or the number of quality clusters used to re-organize and classify the search fingerprint images of the search record 102.

FIG. 4 is a block diagram of a computer system 400. The system 400 can be used to carry out the operations described in association with any of the computer-implemented methods described previously, according to some implementations. In some implementations, computing systems and devices and the functional operations described in this specification can be implemented in digital electronic circuitry, in tangibly-embodied computer software or firmware, in computer hardware, including the structures disclosed in this specification (e.g., system 400) and their structural equivalents, or in combinations of one or more of them. The system 400 is intended to include various forms of digital computers, such as laptops, desktops, workstations, personal digital assistants, servers, blade servers, mainframes, and other appropriate computers, including vehicles installed on base units or pod units of modular vehicles. The system 400 can also include mobile devices, such as personal digital assistants, cellular telephones, smartphones, and other similar computing devices. Additionally, the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The system 400 includes a processor 410, a memory 420, a storage device 430, and an input/output device 440. Each of the components 410, 420, 430, and 440 are interconnected using a system bus 440. The processor 410 is capable of processing instructions for execution within the system 400. The processor may be designed using any of a number of architectures. For example, the processor 410 may be a CISC (Complex Instruction Set Computers) processor, a RISC (Reduced Instruction Set Computer) processor, or a MISC (Minimal Instruction Set Computer) processor.

In one implementation, the processor 410 is a single-threaded processor. In another implementation, the processor 410 is a multi-threaded processor. The processor 410 is capable of processing instructions stored in the memory 420 or on the storage device 430 to display graphical information for a user interface on the input/output device 440.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 may be a floppy disk device, a hard disk device, an optical disk device, or a tape device.

The input/output device 440 provides input/output operations for the system 400. In one implementation, the input/output device 440 includes a keyboard and/or pointing device. In another implementation, the input/output device 440 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer. Additionally, such activities can be implemented via touchscreen flat-panel displays and other appropriate mechanisms.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

The computer system can include clients and servers. A client and server are generally remote from each other and typically interact through a network, such as the described one. The relationship of client and server arises by virtue of computer programs running on the respective computers and having a client-server relationship to each other.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method performed by one or more computers, the method comprising:
obtaining match data for a matching operation between a search record and a reference record, the match data identifying at least:
search fingerprint images included within the search record,
one or more attributes of each of the search fingerprint images,
a selected quality cluster that (i) is associated with the search record, and (ii) comprises one or more search packages, each search package representing a different subset of the search fingerprint images, and
computing a baseline reference match score for the reference record based on the obtained match data;
determining a set of normalization parameters for the selected quality cluster based at least on the one or more attributes of the search fingerprint images;
computing a normalized reference match score for the reference record based on the set of normalization parameters for the selected quality cluster and the baseline reference match score; and
providing the normalized reference match score for output in a match report for the matching operation.

2. The method of claim 1, wherein:
the one or more attributes of the search fingerprint images comprise:
quality levels of each of the search fingerprint images,
finger types of each of the search fingerprint images, and
fingerprint patterns identified in the search fingerprint images; and
the set of normalization parameters for the selected quality cluster is determined based least on the quality levels of each of the search fingerprint images, the finger types of each of the search fingerprint images and the fingerprint patterns identified in the search fingerprint images.

3. The method of claim 2, wherein:
the matching operation is performed according to a matching accuracy requirement;
the match data for matching operation identifies quality levels of the search fingerprint images; and
the method further comprises:
assigning a particular subset of the fingerprints to the one or more search packages based on the matching accuracy requirement and the quality levels of each of the search fingerprint images.

4. The method of claim 1, wherein:
the match data further comprises a respective package match score computed in association with the one or more search packages during the matching operation; and
the baseline reference match score for the reference record is computed based on combining the search package scores for the one or more packages.

5. The method of claim 1, further wherein the method further comprises computing a search packet match score for a particular search package from among the one or more search packets, the computation comprising:
identifying two or more search fingerprint images represented by the particular search package;
obtaining pair match data for the two or more search fingerprint images represented by the particular search package, the pair match data comprising a respective baseline pair match score for each of the two or more search fingerprint images represented by the particular search package;
for each of the two or more search fingerprint images represented by the particular search package:
classifying a particular search fingerprint image as belonging to a particular normalization group based on a finger type of the particular search fingerprint image, fingerprint patterns detected within the particular search fingerprint image, and a quality level of the particular search fingerprint image,
identifying a set of normalization parameters for the particular normalization group, and
computing a normalized pair match score for the particular search fingerprint image based on the set of normalization parameters and a baseline pair match score of the particular search fingerprint image; and
computing the search packet match score for the particular search package based on combining the normalized pair match scores for the two or more search fingerprint images represented by the particular search package.

6. The method of claim 5, wherein:
each baseline pair match score for the two or more search fingerprint images represented by the particular search package reflects a similarity between a particular search fingerprint image and a corresponding reference fingerprint image of the reference record; and
the corresponding reference fingerprint image is associated with a finger type that matches a finger type of the particular search fingerprint image.

7. The method of claim 5, wherein:
the method further comprises:
obtaining training data indicating (i) predefined normalization groups, and (ii) fingerprint data associated with the predefined normalization groups; and
comparing the finger type of the particular search fingerprint image, the fingerprint patterns detected within the particular search fingerprint image, and the quality level of the particular search fingerprint image to corresponding portions of the fingerprint data associated within the predefined normalization groups; and
classifying the particular search fingerprint image as belonging to the particular normalization group comprises:
determining, based on comparing the finger type of the particular search fingerprint image, the fingerprint patterns detected within the particular search fingerprint image, and the quality level of the particular search fingerprint image to corresponding portions of the fingerprint data associated within each of the one or more predefined normalization groups, that a corresponding portion of the fingerprint data associated with a particular predefined normalization group best corresponds to the finger type of the particular search fingerprint image, the fingerprint patterns detected within the particular search fingerprint image, and the quality level of the particular search fingerprint image from among the predefined normalization groups.

8. The method of claim 1, wherein the selected quality cluster represents (i) a quality cluster having search fingerprint images of the highest quality level, and is (ii) selected from among multiple quality clusters that have search fingerprint images of different quality levels.

9. The method of claim 1, wherein providing the normalized reference match score for output in the match report for the matching operation comprises:
determining that the normalized reference match score satisfies a predetermined threshold value; and
in response to determining that the normalized reference match score satisfies the predetermined threshold value, including the normalized reference match score in the match report for the matching operation.

10. A system comprising:
one or more computers; and
one or more storage devices storing instructions that, when executed by the one or more computers, cause the one or more computers to perform operations comprising:
obtaining match data for a matching operation between a search record and a reference record, the match data identifying at least:
search fingerprint images included within the search record,
one or more attributes of each of the search fingerprint images,
a selected quality cluster that (i) is associated with the search record, and (ii) comprises one or more search packages, each search package representing a different subset of the search fingerprint images, and
computing a baseline reference match score for the reference record based on the obtained match data;
determining a set of normalization parameters for the selected quality cluster based at least on the one or more attributes of the search fingerprint images;
computing a normalized reference match score for the reference record based on the set of normalization parameters for the selected quality cluster and the baseline reference match score; and
providing the normalized reference match score for output in a match report for the matching operation.

11. The system of claim 10, wherein:
the one or more attributes of the search fingerprint images comprise:
quality levels of each of the search fingerprint images,
finger types of each of the search fingerprint images, and
fingerprint patterns identified in the search fingerprint images; and
the set of normalization parameters for the selected quality cluster is determined based least on the quality levels of each of the search fingerprint images, the finger types of each of the search fingerprint images and the fingerprint patterns identified in the search fingerprint images.

12. The system of claim 11, wherein:
the matching operation is performed according to a matching accuracy requirement;
the match data for matching operation identifies quality levels of the search fingerprint images; and
the operations further comprise:
assigning a particular subset of the fingerprints to the one or more search packages based on the matching accuracy requirement and the quality levels of each of the search fingerprint images.

13. The system of claim 10, wherein:
the match data further comprises a respective package match score computed in association with the one or more search packages during the matching operation; and
the baseline reference match score for the reference record is computed based on combining the search package scores for the one or more packages.

14. The system of claim 10, further wherein the operations further comprise computing a search packet match score for a particular search package from among the one or more search packets, the computation comprising:
identifying two or more search fingerprint images represented by the particular search package;
obtaining pair match data for the two or more search fingerprint images represented by the particular search package, the pair match data comprising a respective baseline pair match score for each of the two or more search fingerprint images represented by the particular search package;
for each of the two or more search fingerprint images represented by the particular search package:
classifying a particular search fingerprint image as belonging to a particular normalization group based on a finger type of the particular search fingerprint image, fingerprint patterns detected within the particular search fingerprint image, and a quality level of the particular search fingerprint image,
identifying a set of normalization parameters for the particular normalization group, and
computing a normalized pair match score for the particular search fingerprint image based on the set of normalization parameters and a baseline pair match score of the particular search fingerprint image; and
computing the search packet match score for the particular search package based on combining the normalized pair match scores for the two or more search fingerprint images represented by the particular search package.

15. The system of claim 14, wherein:
each baseline pair match score for the two or more search fingerprint images represented by the particular search package reflects a similarity between a particular search fingerprint image and a corresponding reference fingerprint image of the reference record; and
the corresponding reference fingerprint image is associated with a finger type that matches a finger type of the particular search fingerprint image.

16. A non-transitory computer-readable storage device encoded with computer program instructions that, when executed by one or more computers, cause the one or more computers to perform operations comprising:
obtaining match data for a matching operation between a search record and a reference record, the match data identifying at least:
search fingerprint images included within the search record,
one or more attributes of each of the search fingerprint images,
a selected quality cluster that (i) is associated with the search record, and (ii) comprises one or more search packages, each search package representing a different subset of the search fingerprint images, and
computing a baseline reference match score for the reference record based on the obtained match data;
determining a set of normalization parameters for the selected quality cluster based at least on the one or more attributes of the search fingerprint images;
computing a normalized reference match score for the reference record based on the set of normalization parameters for the selected quality cluster and the baseline reference match score; and
providing the normalized reference match score for output in a match report for the matching operation.

17. The device of claim 16, wherein:
the one or more attributes of the search fingerprint images comprise:
quality levels of each of the search fingerprint images,
finger types of each of the search fingerprint images, and
fingerprint patterns identified in the search fingerprint images; and
the set of normalization parameters for the selected quality cluster is determined based least on the quality levels of each of the search fingerprint images, the finger types of each of the search fingerprint images and the fingerprint patterns identified in the search fingerprint images.

18. The device of claim 17, wherein:
the matching operation is performed according to a matching accuracy requirement;
the match data for matching operation identifies quality levels of the search fingerprint images; and
the operations further comprise:
assigning a particular subset of the fingerprints to the one or more search packages based on the matching accuracy requirement and the quality levels of each of the search fingerprint images.

19. The device of claim 16, wherein:
the match data further comprises a respective package match score computed in association with the one or more search packages during the matching operation; and
the baseline reference match score for the reference record is computed based on combining the search package scores for the one or more packages.

20. The device of claim 16, further wherein the operations further comprise computing a search packet match score for a particular search package from among the one or more search packets, the computation comprising:
identifying two or more search fingerprint images represented by the particular search package;
obtaining pair match data for the two or more search fingerprint images represented by the particular search package, the pair match data comprising a respective baseline pair match score for each of the two or more search fingerprint images represented by the particular search package;
for each of the two or more search fingerprint images represented by the particular search package:
classifying a particular search fingerprint image as belonging to a particular normalization group based on a finger type of the particular search fingerprint image, fingerprint patterns detected within the particular search fingerprint image, and a quality level of the particular search fingerprint image,
identifying a set of normalization parameters for the particular normalization group, and
computing a normalized pair match score for the particular search fingerprint image based on the set of normalization parameters and a baseline pair match score of the particular search fingerprint image; and
computing the search packet match score for the particular search package based on combining the normalized pair match scores for the two or more search fingerprint images represented by the particular search package.
